(19) United States
(12) Patent Application Publication
(10) Pub. No.: US 2026/0063808 A1
(43) Pub. Date: Mar. 5, 2026

(54) VEHICLE-MOUNTED GNSS POSITIONING METHOD BASED ON MULTI-MOTION MODEL INTERACTION

(71) Applicant: SOUTHEAST UNIVERSITY, Jiangsu (CN)

(72) Inventors: Wang GAO, Jiangsu (CN); Hong HUANG, Jiangsu (CN); Xianlu TAO, Jiangsu (CN); Shuguo PAN, Jiangsu (CN); Qing ZHAO, Jiangsu (CN)

(73) Assignee: SOUTHEAST UNIVERSITY, Jiangsu (CN)

(21) Appl. No.: 19/325,508

(22) Filed: Sep. 11, 2025

Related U.S. Application Data
(63) Continuation of application No. PCT/CN2025/088907, filed on Apr. 15, 2025.

(30) Foreign Application Priority Data
Sep. 4, 2024 (CN) 202411233557.X

(51) Int. Cl. G01S 19/47; G01S 19/25; G01S 19/39; G01S 19/52; G06F 18/2433; G06F 18/25

(52) U.S. Cl. CPC G01S 19/47; G01S 19/254; G01S 19/396; G01S 19/52; G06F 18/2433; G06F 18/251; G06F 18/256

(57) ABSTRACT

A vehicle-mounted GNSS positioning method based on multi-motion model interaction includes: establishing a position-constant velocity (PCV) model and a position-constant steering angular velocity (PCSAV) model for two attitudes of a carrier (i.e., linear motion and turning motion) respectively to obtain a state estimation vector and a state transition matrix of the carrier of the PCV model and the PCSAV model at a previous moment, introducing an interacting multiple model (INM), establishing a heuristic position-velocity filtering (HPV)-IMM model based on the IMM model to achieve an information filtering interaction between the PCV model and the PCSAV model, and obtaining a state estimation vector and an error covariance matrix of the carrier at a current moment, so as to obtain a position and velocity of the carrier at the current moment. The present disclosure solves the problem of low accuracy of a traditional single kinematic model in multi-motion attitude vehicle positioning.

### CROSS-REFERENCE TO RELATED APPLICATION

This application is a continuation of international application of PCT application serial no. PCT/CN2025/088907, filed on Apr. 15, 2025, which claims the priority benefit of China application no. 202411233557.X, filed on Sep. 4, 2024. The entirety of each of the above-mentioned patent applications is hereby incorporated by reference herein and made a part of this specification.

### TECHNICAL FIELD

The present disclosure relates to the technical field of vehicle navigation and positioning, and in particular to a vehicle-mounted global navigation satellite system (GNSS) positioning method based on multi-motion model interaction.

### BACKGROUND

In an open and interference-free environment, the accuracy of single point positioning (SPP) by an ordinary vehicle-mounted navigation receiver may reach the meter level, and the accuracy of real-time differential (RTD) positioning may reach the sub-meter level. However, a large number of urban scenes such as canyons, tree-lined areas, tunnels, and viaducts easily cause obstruction and spoofing of satellite signals. Severe non-line-of-sight (NLOS) and multipath effects cause failure to guarantee the availability and continuity of SPP/RTD positioning, and the positioning error may escalate to tens of meters or even hundreds of meters in extreme environments. To address the above challenges and improve the robustness and anti-interference capability of the navigation system when abnormal observation data are available, roughly two types of solutions are employed without dependence on external sensor information assistance:

First, in the observation domain, representative methods include fault detection and exclusion (FDE) and robust estimation. The core goal of FDE is to identify and exclude observation data with significant deviations by executing a series of statistical test procedures, so as to ensure the accuracy and stability of system output. Robust estimation focuses on optimizing the matching between observation values and their weights to reduce the adverse effects of those observation values with large errors and high weights on overall filtering results. Both the above two methods may be implemented based on prior innovations and posterior residuals. FDE and robust estimation based on the posterior residuals comprehensively consider the prior innovations and observation data, and better reflect the distribution of observation residuals at the current moment. However, due to the correlation between observation values, some gross errors are allocated to other normal observation values, which easily leads to missed detection and false alarms. Although FDE and robust estimation based on prior innovations may eliminate the negative impact of gross error transfer, they impose more stringent requirements for the accuracy of state forecasting.

Second, in the state domain, most navigation receivers currently available on the market are capable of receiving Doppler observation signals, and the accuracy of GNSS multi-system single-point velocity measurement reaches the cm/s level. In view of relative stability of a vehicle's motion state, a method of predicting the current coordinates based on a carrier's prior coordinates and Doppler velocity measurement information is more robust than a traditional single-point positioning coordinate update method. Over the past two decades, many scholars have discussed carrier motion models and established various models including a constant velocity (CV) model and a constant acceleration (CA) model to describe carrier motion behaviors. The CV model is the most widely used, but is too ideal and difficult to accurately describe a complex motion state of the vehicle driving in urban areas, and the prediction effect is poor especially when the vehicle is in a large-curvature turning state.

### SUMMARY

Invention objective: an objective of the present disclosure is to provide a vehicle-mounted global navigation satellite system (GNSS) positioning method based on multi-motion model interaction, and the method is used to improve the accuracy and continuity of GNSS positioning under multiple vehicle motion attitudes.

Technical solution: to achieve the above objective, the vehicle-mounted GNSS positioning method based on multi-motion model interaction is described in the present disclosure, including:
establishing a heuristic position-velocity filtering with constant velocity model (PCV) and a position-velocity filtering with constant steering angular velocity model (PCSAV) for two attitudes of a carrier (i.e., linear motion and turning motion) respectively to obtain a state estimation vector and a state transition matrix of the carrier of the PCV model and the PCSAV model at a previous moment, where the state estimation vector includes a position and velocity of the carrier, and the state transition matrix is configured to transform the state estimation vector at the previous moment into the state prediction vector at the current moment; and
introducing an interacting multiple model (IMM), and establishing a heuristic position-velocity filtering (HPV)-IMM model based on the IMM model, where the HPV-IMM model performs the measurement update on a state prediction vector and the error covariance matrix of the carrier of the PCV model and the PCSAV model at the current moment, to obtain the state estimation vector and the error covariance matrix of the carrier of the PCV model and the PCSAV model at the current moment after the measurement update; and fusing the state estimation vector and the error covariance matrix of the carrier of the PCV model and the PCSAV model at the current moment after the measurement update to obtain the overall state estimation vector and the error covariance matrix of the carrier at the current moment, and obtaining the position and velocity of the carrier at the current moment according to the overall state estimation vector of the carrier at the current moment.
in the PCV model, the state vector of the carrier to be estimated is expressed as follows:

$${X}_{P C V} = [ x , y , z , {V}_{x} , {V}_{y} , {V}_{z} ] ;$$

the state transition matrix of the carrier is expressed as follows:

$${Φ}_{P C V} = [ \begin{matrix}1 & & & dt & & \\ & 1 & & & dt & \\ & & 1 & & & dt \\ & & & 1 & & \\ & & & & 1 & \\ & & & & & 1\end{matrix} ] ;$$

where dt represents a time interval between adjacent epochs; (x,y,z) denotes a position of the carrier at a certain moment, (Vₓ, V_{y}, V_{z}) signifies a velocity of the carrier at the position (x,y,z); and the state transition matrix transfers the state vector from the previous moment to the next moment according to the time interval dt.

The PCV and PCSAV models represent different motion dynamics, and share the same state vector structure, with identical variable definitions and dimensionality. In the PCSAV model, the state vector of the carrier to be estimated may be expressed as follows:

$${X}_{P C S A V} = {X}_{P C V} ,$$

where X_{PCV} represents the state vector of the carrier to be estimated in the PCV model;
the state transition matrix of the carrier is expressed as follows:

$${Φ}_{P C T R V} = [ \begin{matrix}1 & & & \\ & 1 & & {H}^{T} Rot ( ω dt / 2 ) H \\ & & 1 & \\ & & & {H}^{T} Rot ( ω dt ) H\end{matrix} ] ,$$

where ω(T) represents an angular velocity of the carrier at a moment T; and H represents a matrix of conversion from an Earth-Centered Earth-Fixed (ECEF) coordinate system to an East-North-Up (ENU) coordinate system.

The HPV-IMM model includes a state interaction input module, a state prediction module, an innovation outlier detection module, a measurement update module, and an overall output interaction module;
the state interaction input module, according to an estimation result of a state vector of the carrier of an i^{th} sub-model at a previous moment k, calculates an initial state vector

$${\tilde{X}}_{k + 1 / k}^{i}$$

and an error covariance matrix

$${\tilde{P}}_{k + 1 / k}^{i}$$

of the carrier of the i^{th} sub-model at a current moment k+1, where when i=1, the i^{th} sub-model represents the PCV model, and when i=2 or M, the i^{th} sub-model represents the PCSAV model, and M=2 represents the number of sub-models;
according to the initial state vector

$${\tilde{X}}_{k + 1 / k}^{i}$$

and the error covariance matrix

$${\tilde{P}}_{k + 1 / k}^{i} ,$$

the state prediction module predicts a motion state of the carrier of the i^{th} sub-model from the moment k to the moment k+1, and calculates a state prediction vector

$${\overline{X}}_{k + 1 / k}^{i}$$

and an error covariance matrix

$${\overline{P}}_{k + 1 / k}^{i}$$

of the carrier of the i^{th} sub-model from the moment k to the moment k+1;
according to the state prediction vector

$${\overline{x}}_{k + 1 / k}^{i}$$

and the error covariance matrix

$${\overline{P}}_{k + 1 / k}^{i}$$

of the carrier of the i^{th} sub-model, the innovation outlier detection module calculates an innovation sequence

$${L}_{k + 1}^{i}$$

of the i^{th} sub-model at the moment k+1;
the measurement update module includes a measurement update and a sub-model probability update, where the measurement update is performed based on the state prediction vector

$${\overline{X}}_{k + 1 / k}^{i} ,$$

the error covariance matrix

$${\overline{P}}_{k + 1 / k}^{i} ,$$

and the innovation sequence

$${L}_{k + 1}^{i}$$

of the carrier of the i^{th} sub-model to obtain a state vector

$${\hat{X}}_{k + 1 / k + 1}^{i}$$

and an error covariance matrix

$${\hat{P}}_{k + 1 / k + 1}^{i}$$

of the carrier of the i^{th} sub-model after the measurement update; for the sub-model probability update, similarity between a motion state of the carrier predicted by the i^{th} sub-model and a current motion state of the carrier is calculated to obtain a posterior probability

$${\hat{μ}}_{k + 1}^{i}$$

of the i^{th} sub-model;
the overall output interaction module performs weighted fusion of the state estimation vector

$${\hat{X}}_{k + 1 / k + 1}^{i}$$

and the error covariance matrix

$${\hat{P}}_{k + 1 / k + 1}^{i}$$

of the carrier of the i^{th} sub-model according to the posterior probability

$${\hat{μ}}_{k + 1}^{i} ,$$

to obtain \hat{X}_{k+1/k+1} and an error covariance matrix \hat{P}_{k+1/k+1}; and
the position and velocity of the carrier at the moment k+1 are calculated based on the overall state estimation vector of the carrier at the moment k+1.

The initial state vector

$${\tilde{X}}_{k + 1 / k}^{i}$$

and the error covariance matrix

$${\tilde{P}}_{k + 1 / k}^{i}$$

of the carrier of the i^{th} sub-model are expressed as follows:

$${\tilde{X}}_{k + 1 / k}^{i} = {\sum }_{j = 1}^{M} {\hat{X}}_{k / k}^{j} {μ}_{k + 1 / k}^{i \vert j} ,$$

$${\overline{P}}_{k + 1 / k}^{i} = {\sum }_{j = 1}^{M} [ {\hat{P}}_{k / k}^{j} + ( {\tilde{X}}_{k / k}^{i} - {\hat{X}}_{k / k}^{j} ) {( {\tilde{X}}_{k / k}^{i} - {\hat{X}}_{k / k}^{j} )}^{T} ] {μ}_{k / k + 1}^{i \vert j} ;$$

where

$${m}_{k}^{i} ▯ \{ {P}_{k - 1 / k - 1}^{i} , {Φ}_{k}^{i} , {Q}_{k}^{i} , {B}_{k}^{i} , {R}_{k}^{i} \}$$

represents parameters of the i^{th} sub-model at the moment k, including an error covariance matrix

$${P}_{k - 1 / k - 1}^{i} ,$$

a state transition matrix

$${Φ}_{k}^{i} ,$$

a process noise matrix

$${Q}_{k}^{i} ,$$

a coefficient matrix

$${B}_{k}^{i} ,$$

and an observation noise matrix

$${R}_{k}^{i} ;$$

$${Z}_{k} = [ {Z}_{k}^{P R} , {Z}_{k}^{D O P} ] ,$$

represents observation data at the moment k, including a pseudorange value

$${Z}_{k}^{P R}$$

and a Doppler measurement value

$${Z}_{k}^{D O P}$$

of a satellite; and

$${μ}_{k + 1 / k}^{i \vert j} ⊔ P \{ {m}_{k + 1}^{i} \vert {m}_{k}^{j} , {Z}_{k}^{j} \} = \frac{{π}_{ij} {\hat{μ}}_{k}^{j}}{{\overline{μ}}_{k + 1 / k}^{i}} ,$$

represents a probability of transition from

$${m}_{k}^{j} to {m}_{k + 1}^{i} ; {\overline{μ}}_{k + 1 / k}^{i} = {\sum }_{j = 1}^{M} {π}_{ij} {\hat{μ}}_{k}^{j} ,$$

represents a probability of the sub-model after an interaction in the interaction input module, which is calculated based on a prior transition probability matrix π and a model posterior probability

$${\hat{μ}}_{k}^{J} ,$$

where the transition probability matrix is set as

$$π = [ \begin{matrix}0.95 & 0.05 \\ 0.05 & 0.95\end{matrix} ] .$$

The state prediction vector

$${\overline{X}}_{k + 1 / k}^{i}$$

and the error covariance matrix

$${\overline{P}}_{k + 1 / k}^{i}$$

of the carrier of the i^{th} sub-model from the moment k to the moment k+1 are expressed as follows:

$${\overline{X}}_{k + 1 / k}^{i} = {Φ}_{k + 1}^{i} {\tilde{X}}_{k + 1 / k}^{i} , {\overline{P}}_{k + 1 / k}^{i} = {Φ}_{k + 1}^{i} {\tilde{P}}_{k + 1 / k}^{i} {Φ}_{k + 1}^{iT} + {Q}_{k + 1}^{i} ;$$

where

$${Φ}_{k + 1}^{i}$$

represents a state transition matrix of the carrier of the i^{th} sub-model at the moment k+1, and

$${Q}_{k + 1}^{i}$$

represents a process noise matrix of the carrier of the i^{th} sub-model at the moment k+1.

The innovation sequence

$${L}_{k + 1}^{i}$$

of the i^{th} sub-model at the moment k+1 is expressed as follows:

$${L}_{k + 1}^{i} = {\tilde{Z}}_{k + 1} - {B}_{k + 1}^{i} {\overline{X}}_{k + 1 / k}^{i} ;$$

where \tilde{Z}ₖ₊₁ represents observation data after gross error elimination at the moment k+1, and Bₖ₊₁ⁱ represents a coefficient matrix of the i^{th} sub-model at the moment k+1.

A multi-dimensional statistical analysis-based outlier detection algorithm is configured to identify and eliminate an observation gross error in the observation values, and the observation gross error refers to an error of the observation values greater than a preset threshold of observation values.

The state estimation vector

$${\hat{X}}_{k + 1 / k + 1}^{i}$$

and the error covariance matrix

$${\hat{P}}_{k + 1 / k + 1}^{i}$$

of the carrier of the i^{th} sub-model after the measurement update are expressed as follows:

$${{X}^{⌢}}_{k + 1 / k + 1}^{j} = {\overline{X}}_{k + 1 / k}^{j} + {K}_{k + 1}^{i} {L}_{k + 1}^{i} ,$$

$${\hat{P}}_{k + 1 / k + 1}^{j} = ( 1 - {K}_{k + 1}^{i} {B}_{k + 1}^{i} ) {\overline{P}}_{k + 1 / k}^{i} ;$$

where I represents an identity matrix (unity (1) elements along the principal diagonal), and

$${B}_{k + 1}^{i}$$

represents the coefficient matrix of the i^{th} sub-model at the moment k+1;

$${K}_{k + 1}^{i}$$

represents a Kalman gain

$${K}_{k + 1}^{i} = {\overline{P}}_{k + 1 / k}^{i} {{B}_{k + 1}^{iT} ( {B}_{k + 1}^{i} {\overline{P}}_{k + 1 / k}^{i} {B}_{k + 1}^{iT} + {R}_{k + 1}^{i} )}^{- 1} ;$$

the posterior probability

$${\hat{μ}}_{k + 1}^{i}$$

of the i^{th} sub-model is expressed as follows:

$${\hat{μ}}_{k + 1}^{i} = \frac{{\overline{μ}}_{k + 1 / k}^{i} {Λ}_{k + 1}^{i}}{{\sum }_{i = 1}^{M} {\overline{μ}}_{k + 1 / k}^{i} {Λ}_{k + 1}^{i}} ;$$

where

$${Λ}_{k + 1}^{i}$$

represents a likelihood function value of the i^{th} sub-model at the moment k+1.

The \hat{X}_{k+1/k+1} and the error covariance matrix \hat{P}_{k+1/k+1} obtained after the weighted fusion, i.e., the overall state estimation vector and the error covariance matrix of the carrier at the moment k+1 are expressed as follows:

$${\hat{X}}_{k + 1 / k + 1} = {\sum }_{i = 1}^{M} {\hat{X}}_{k + 1 / k + 1}^{i} {\hat{μ}}_{k + 1}^{i} ,$$

$${\hat{P}}_{k + 1 / k + 1} = {\sum }_{i = 1}^{M} [ {\hat{P}}_{k + 1 / k + 1}^{i} + ( {\hat{X}}_{k + 1 / k + 1} - {\hat{X}}_{k + 1 / k + 1}^{i} ) \cdot {( {\hat{X}}_{k + 1 / k + 1} - {\hat{X}}_{k + 1 / k + 1}^{i} )}^{T} ] {\hat{μ}}_{k + 1}^{i} .$$

### BRIEF DESCRIPTION OF THE DRAWINGS

FIG. 1 illustrates a heuristic PCV model.

FIG. 2 illustrates a heuristic PCSAV model.

FIG. 3 is a schematic flow diagram of an information filtering interaction between a PCV model and a PCSAV model achieved by an interacting multiple model.

FIGS. 4A and 4B are schematic diagrams of a real-time interaction between a PCV model and a PCSAV model in an open scene achieved by an interacting multiple model.

FIG. 5A is a schematic diagram of comparing positioning errors of the HPV-IMM model, PV model, and RTD model.

FIG. 5B is a schematic diagram of comparing velocity measurement errors of the HPV-IMM model, PV model, and SPV model.

FIG. 6 illustrates positioning effects of an HPV-IMM model in a complex environment before and after applying an MSA-OD algorithm.

### DETAILED DESCRIPTIONS OF THE EMBODIMENTS

The technical solution of the present disclosure will be described in detail below with reference to the examples and accompanying drawings.

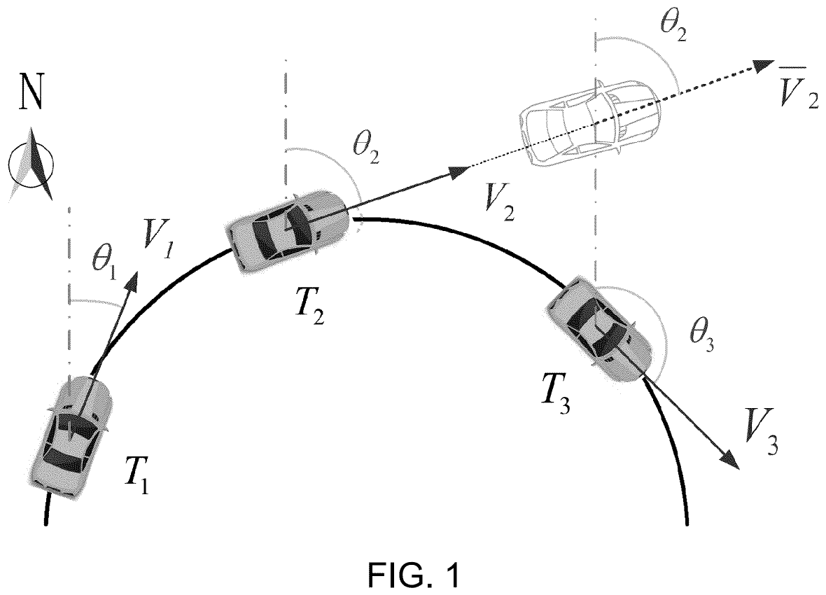

A vehicle-mounted GNSS positioning method based on multi-motion model interaction provided in the present disclosure includes the following steps:
step 1: establish a heuristic position-velocity filtering with constant velocity model (PCV) and a position-velocity filtering with constant steering angular velocity model (PCSAV) for two attitudes (i.e., linear motion and turning motion) of a carrier (a vehicle);
the heuristic PCV model is shown in FIG. 1, when the carrier (the vehicle) is in a linear motion state, the carrier may be constrained to the PCV model, that is, it is considered that compared with that at a moment T₂, a motion velocity of the carrier remains unchanged in magnitude and direction at a moment T₃, and a position the carrier at the moment T₃ is predicted based on an instantaneous velocity at the moment T₂.

In the PCV model, a clock error and clock rate of a vehicle-mounted receiver are eliminated by inter-satellite differencing, and a state vector of the carrier to be estimated may be expressed as follows:

$${X}_{PCV} = [ x , y , z , {V}_{x} , {V}_{y} , {V}_{z} ] ; \qquad ( 1 )$$

### a State Transition Matrix of the Carrier is Expressed as Follows:

$${Φ}_{PCV} = [ \begin{matrix}1 & & & dt & & \\ & 1 & & & dt & \\ & & 1 & & & dt \\ & & & 1 & & \\ & & & & 1 & \\ & & & & & 1\end{matrix} ] ; \qquad ( 2 )$$

where dt represents a time interval between adjacent epochs; (x,y,z) denotes a position of the carrier at a certain moment, (Vₓ, V_{y}, V_{z}) signifies a velocity of the carrier at the position (x,y,z); the state vector usually includes a position and velocity of the carrier at a certain moment, and the state transition matrix transfers the state vector from the previous moment to the next moment according to the time interval dt.

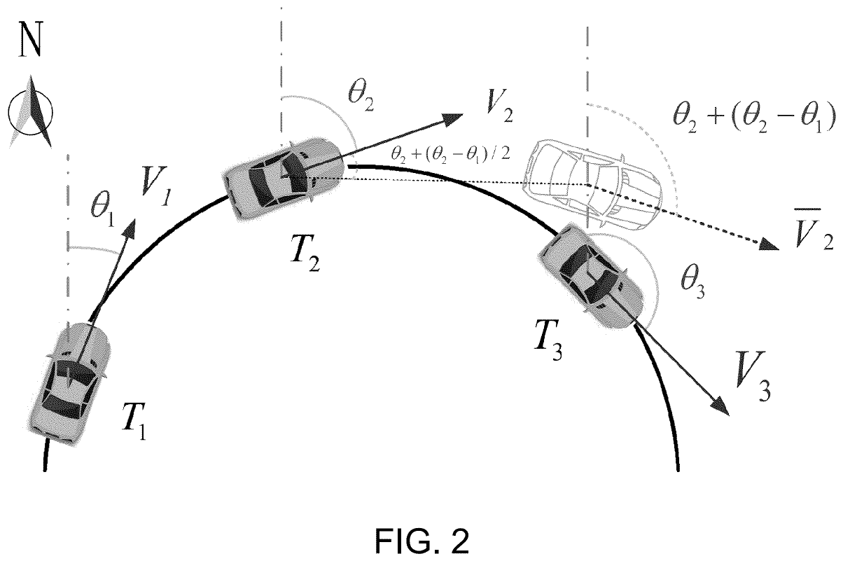

The heuristic PCSAV model is shown in FIG. 2, when the carrier is in a turning motion state, it is constrained to the PCSAV model, that is, it is considered that compared with that at the moment T₂, the motion velocity of the carrier remains unchanged in magnitude at the moment T₃, the direction is corrected by an angular velocity of the carrier during motion at the moment T₂, and the position of the carrier at the moment T₃ is predicted based on an average velocity of the carrier from the moment T₂ to the moment T₃.

In the PCSAV model, the state vector of the carrier to be estimated may be expressed as follows:

$${X}_{PCSAV} = {X}_{PCV} ; \qquad ( 3 )$$

### The State Transition Matrix of the Carrier May be Expressed as Follows:

$${Φ}_{PCTRV} = [ \begin{matrix}1 & & & & \\ & 1 & & & {H}^{T} Rot ( ω dt / 2 ) Hdt \\ & & 1 & & \\ & & & & {H}^{T} Rot ( ω dt / 2 ) H\end{matrix} ] ; \qquad ( 4 )$$

$$where : ω ( T ) = \frac{θ ( T ) - θ ( T - 1 )}{dt} , θ = arctan ( {V}_{e} / {V}_{n} ) ; \qquad ( 5 )$$

represents an angular velocity of the carrier at the moment T, i.e., a heading change rate of the carrier, which may be derived from a heading angle θ at the current moment and the previous moment, and the heading angle θ may be calculated based on velocities (Vₑ, Vₙ) of the carrier in east (E) and north (N).

$$H = [ \begin{matrix}- sin L & cos L & 0 \\ - sin B cos L & - sin B sin L & cos B \\ cos B cos L & cos B sin L & sin B\end{matrix} ] ; \qquad ( 6 )$$

represents a matrix of conversion from an Earth-Centered Earth-Fixed (ECEF) coordinate system to an East-North-Up (ENU) coordinate system, B and L denote a latitude and longitude of the carrier in an initial state vector

$${\tilde{X}}_{k + 1 / k}^{i}$$

of the PCV or PCSAV model.

$$Rot ( φ ) = [ \begin{matrix}cos φ & sin φ & 0 \\ - sin φ & cos φ & 0 \\ 0 & 0 & 1\end{matrix} ] ; \qquad ( 7 )$$

represents a rotation matrix obtained by rotating a horizontal component of velocity of the carrier by φ degrees around an origin.

The heuristic PCV model and the PCSAV model established by the present disclosure do not rely on data input from external sensors. All parameters of the two models are calculated solely based on data at the current moment and the previous moment, which reduces the computational complexity and significantly improves the real-time performance of vehicle position calculation than that achieved by some methods that require sliding window fitting trajectories for motion constraints.

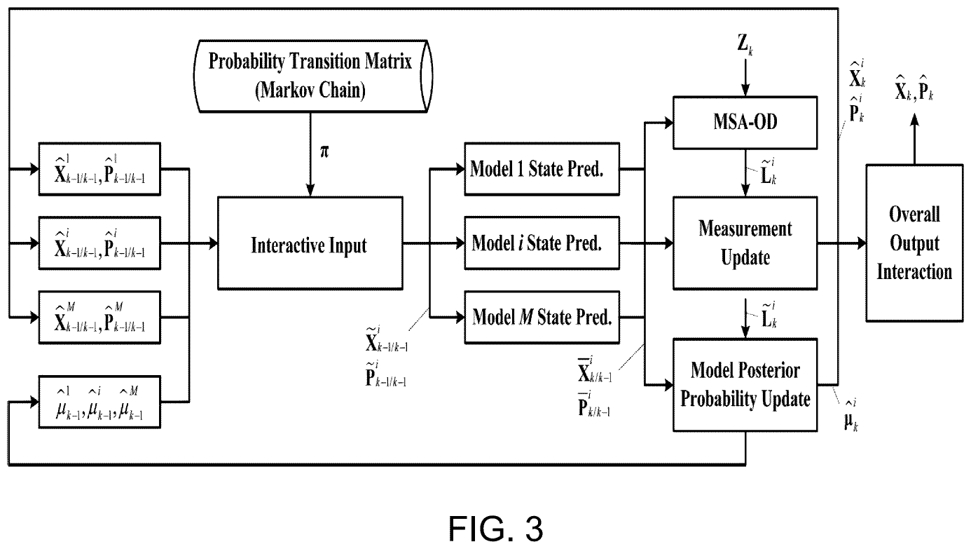

Step 2: As shown in FIG. 3, establish an interacting multiple model (an HPV-INM model) to achieve an information filtering interaction between the PCV model and the PCSAV model; and
the HPV-IMM model includes five modules: a state interaction input module, a state prediction module, an innovation outlier detection module, a measurement update module (including a measurement update and a sub-model probability update), and an overall output interaction module.
(1) The state interaction input module, according to the state estimation (referring to an estimation result of the state vector of the sub-model) of the sub-model (including the PCV model and the PCSAV model) at a previous moment, a posterior probability of the sub-model, and a transition probability matrix π, calculates an initial state vector

$${\tilde{X}}_{k + 1 / k}^{i}$$

and an error covariance matrix

$${\tilde{P}}_{k + 1 / k}^{i}$$

of the carrier of the th sub-model at a current moment k+1, where when i=1, the sub-model represents the PCV model, and when i=2 or M, the sub-model represents the PCSAV model, and M=2 represents the number of sub-models.

Different from an extended Kalman filter (EKF) of a single model, in the state prediction process, the interacting multiple model does not directly use a state estimation value and error covariance matrix of a previous epoch for the state prediction of a current epoch, but initializes the sub-model at the beginning of each epoch and performs interactive fusion in the state domain.

According to the theorem of total probability, a probability density function (PDF) of state estimation of each sub-model at the moment k+1 may be initialized as follows:

$$\tilde{p} ( {X}_{k} \vert {m}_{k + 1}^{i} , {Z}_{k} ) = {\sum }_{j = 1}^{M} {μ}_{k + 1 / k}^{i \vert j} \hat{p} ( {X}_{k} \vert {m}_{k}^{j} , {Z}_{k} ) , \qquad ( 8 )$$

an initial state vector and an error covariance matrix of each sub-model at the moment k+1 are expressed as follows:

$${\tilde{X}}_{k + 1 / k}^{i} = {\sum }_{j = 1}^{M} {\hat{X}}_{k / k}^{j} {μ}_{k + 1 / k}^{i \vert j} ; \qquad ( 9 )$$

$${\tilde{P}}_{k + 1 / k}^{i} = {\sum }_{j = 1}^{M} [ {\hat{P}}_{k / k}^{j} + ( {\tilde{X}}_{k / k}^{i} - {\hat{X}}_{k / k}^{j} ) {( {\tilde{X}}_{k / k}^{i} - {\hat{X}}_{k / k}^{j} )}^{T} ] {μ}_{k / k + 1}^{i \vert j} ; \qquad ( 10 )$$

$$where , {m}_{k}^{i} ▯ \{ {P}_{k - 1 / k - 1}^{i} , {Φ}_{k}^{i} , {Q}_{k}^{i} , {B}_{k}^{i} , {R}_{k}^{i} \} , \qquad ( 11 )$$

represents relevant parameters of the i^{th} sub-model at the moment k, including an error covariance matrix

$${P}_{k - 1 / k - 1}^{i} ,$$

a state transition matrix

$${Φ}_{k}^{i} ,$$

a process noise matrix

$${Q}_{k}^{i} ,$$

a coefficient matrix

$${B}_{k}^{i} ,$$

and an observation noise matrix

$${R}_{k}^{i} .$$

$${Z}_{k} = [ {Z}_{k}^{PR} , {Z}_{k}^{DOP} ] , \qquad ( 12 )$$

represents observation data at the moment k, specifically including a pseudorange value and a Doppler measurement value of a satellite in this example.

$${μ}_{k + 1 / k}^{i \vert j} ⊔ P \{ {m}_{k + 1}^{i} \vert {m}_{k}^{j} , {Z}_{k}^{j} \} = \frac{{π}_{ij} {\hat{μ}}_{k}^{j}}{{\overline{μ}}_{k + 1 / k}^{i}} {\overline{μ}}_{k + 1 / k}^{i} = {\sum }_{j = 1}^{M} {π}_{ij} {\hat{μ}}_{k}^{j} , \qquad ( 13 )$$

represents a probability of transition from

$${m}_{k}^{j} to {m}_{k + 1}^{i} ,$$

which may be calculated based on a prior transition probability matrix (TPM) Π and the posterior probability of the sub-model.

The superscript “-” of the above variables represents a prediction result (prior), “˜” represents an interaction result, “\hat{ }” represents an estimation result (posterior) after the measurement update, the posterior probability of the sub-model refers to

$${\hat{μ}}_{k}^{i}$$

after the probability update, the transition probability matrix is

$$π = [ \begin{matrix}0.95 & 0.05 \\ 0.05 & 0.95\end{matrix} ]$$

the subscript k/k represents a variable at a moment k, the subscript k−1/k−1 represents a variable at a moment k−1, and the subscript k+1/k represents a variable at the moment k+1 predicted based on that at the moment k.
(2) The state prediction module is independent in each sub-model filter (i.e., each sub-model filter has a state prediction module), and based on the initialized state vector

$${\tilde{X}}_{k + 1 / k}^{i}$$

and the error covariance matrix

$${\tilde{P}}_{k + 1 / k}^{i}$$

obtained through the state interaction input module, a motion state of the carrier of the sub-model from the moment k to the moment k+1 is predicted:

$${\overline{X}}_{k + 1 / k}^{i} = {Φ}_{k + 1}^{i} {\tilde{X}}_{k + 1 / k}^{i} \qquad ( 14 )$$

$${\overline{P}}_{k + 1 / k}^{i} = {Φ}_{k + 1}^{i} {\tilde{P}}_{k + 1 / k}^{i} {Φ}_{k + 1}^{i T} + {Q}_{k + 1}^{i} \qquad ( 15 )$$

where

$${\overline{X}}_{k + 1 / k}^{i}$$

represent a state prediction vector and an error covariance matrix

$${\overline{P}}_{k + 1 / k}^{i}$$

of the carrier of the i^{th} sub-model from the moment k to the moment k+1, and

$${Φ}_{k + 1}^{i}$$

represents the state transition matrix of the carrier of the sub-model at the moment k+1.
(3) The outlier detection module, based on the state prediction vector

$${\overline{X}}_{k + 1 / k}^{i}$$

obtained by the state prediction module, calculates an innovation sequence

$${L}_{k + 1}^{i}$$

of the sub-model filter at the moment k+1:

$${L}_{k + 1}^{i} = {\tilde{Z}}_{k + 1} - {B}_{k + 1}^{i} {\overline{X}}_{k + 1 / k}^{i} \qquad ( 16 )$$

where \tilde{Z}ₖ₊₁ represents observation data after gross error elimination at the moment k+1, and

$${B}_{k + 1}^{i}$$

represents a coefficient matrix of the i^{th} sub-model at the moment k+1.

### Where,

$${L}_{k + 1}^{i} = [ {L}_{k + 1}^{P R , i} , {L}_{k + 1}^{DOP , i} ] \qquad ( 17 )$$

where

$${L}_{k + 1}^{PR , i}$$

represents a pseudorange innovation sequence, and

$${L}_{k + 1}^{DOP , i}$$

represents a Doppler innovation sequence.

In pseudorange single-point positioning and Doppler single-point velocity measurement, original pseudorange and Doppler observation equations may be expressed as follows:

$${\tilde{Z}}^{PR , i} = {Z}^{PR} - {ρ}^{i} - c d {t}_{r}^{i} + c d {t}_{s}^{i} - {d}_{t r o p}^{i} - {d}_{i o n}^{i} - {ε}^{F R} \qquad ( 18 )$$

$${\tilde{Z}}^{D O P , i} = λ {Z}^{D O P} - {\dot{ρ}}^{i} - c \dot{d} {t}_{r}^{i} + c \dot{d} {t}_{s}^{i} - {\dot{d}}_{t r o p}^{i} - {\dot{d}}_{i o n}^{i} - {ε}^{D O P} \qquad ( 19 )$$

On the basis of ignoring modeling errors including a satellite clock error cdtₛ, an ionospheric delay dᵢₒₙ, and a tropospheric delay dₜᵣₒₚ, it can be known from the above observation equations that the pseudorange innovation sequence

$${L}_{k + 1}^{PR}$$

mainly includes a receiver clock error cdtᵣ, a satellite-to-ground distance ρ deviation caused by a predicted position deviation, and pseudorange observation noise ε^{PR}. Like the pseudorange innovation sequence, the Doppler innovation sequence

$${L}_{k + 1}^{DOP}$$

mainly includes a receiver clock rate c\dot{d}tᵣ, a satellite-to-ground distance change rate \dot{ρ} deviation caused by a predicted velocity deviation, and Doppler observation noise ε^{DOP}.

On the premise of ensuring that errors of the predicted position and velocity fall within an acceptable range, the pseudorange innovation sequence and the Doppler innovation sequence may be regarded as data sequences that are biased but overall stable. Sequence outliers caused by gross errors in observation values may be effectively identified and eliminated by using an MSA-OD algorithm. It is worth noting that in the process of outlier identification, the presence of inter-system bias (ISB) of satellite systems such as GPS and BeiDou requires independent analysis of pseudorange innovation sequences from different systems. In contrast, the special independent analysis is not required for analysis of the Doppler sequence.
(4) The model measurement update module is included in each independent filter, and the measurement update is performed based on the

$${\overline{X}}_{k + 1 / k}^{i}$$

state prediction vector, the error covariance matrix

$${\overline{P}}_{k + 1 / k}^{i} ,$$

and the innovation sequence

$${L}_{k + 1}^{i}$$

through EKF, to obtain a state vector

$${\hat{X}}_{k + 1 / k + 1}^{i}$$

and an error covariance

$${\hat{P}}_{k + 1 / k + 1}^{i}$$

after the measurement update:

### Calculate the Kalman Gain as Follows:

$${K}_{k + 1}^{i} = {\overline{P}}_{k + 1 / k}^{i} {{B}_{k + 1}^{i T} ( {B}_{k + 1}^{i} {\overline{P}}_{k + 1 / k}^{i} {B}_{k + 1}^{i T} + {R}_{k + 1}^{i} )}^{- 1} ; \qquad ( 20 )$$

### Update the State as Follows:

$${{X}^{︵}}_{k + 1 / k + 1}^{i} = {\overline{X}}_{k + 1 / k}^{i} + {K}_{k + 1}^{i} + {L}_{k + 1}^{i} ; \qquad ( 21 )$$

### Update the Error Covariance as Follows:

$${\hat{P}}_{k + 1 / k + 1}^{i} = ( I - {K}_{k + 1}^{i} {B}_{k + 1}^{i} ) {\overline{P}}_{k + 1 / k}^{i} . \qquad ( 22 )$$

I represents an identity matrix (unity (1) elements along the principal diagonal).

The posterior probability of the sub-model is updated based on a current epoch and a likelihood function value of the model. That is, similarity between a motion state of the carrier predicted by the sub-model and a current motion state of the carrier is calculated to obtain a probability most suitable for the current sub-model. The pseudorange and Doppler observation values theoretically conform to a normal distribution, and the likelihood function value may be expressed by the following formula:

$${Λ}_{k + 1}^{i} ▯L \{ {X}_{k + 1}^{i} \vert {m}_{k + 1}^{i} , {Z}_{k + 1}^{i} \} = \frac{1}{\sqrt{det ( 2 π {S}_{k + 1}^{i} )}} exp [ - \frac{1}{2} {L}_{k + 1}^{i T} {S}_{k + 1}^{i - 1} {L}_{k + 1}^{i} ] \qquad ( 23 )$$

where det( ) means calculating a determinant of a square matrix;

$${S}_{k + 1}^{i} = {B}_{k + 1}^{i} {P}_{k + 1 / k}^{i} {B}_{k + 1}^{i T} + {R}_{k + 1}^{i} \qquad ( 24 )$$

the above is an innovation error covariance calculated by a law of error propagation.

Therefore, according to Bayes' theorem, the posterior probability of the sub-model may be expressed as follows:

$${\hat{μ}}_{k + 1}^{i} = \frac{{\overline{μ}}_{k + 1 / k}^{i} {Λ}_{k + 1}^{i}}{{\sum }_{i = 1}^{M} {\overline{μ}}_{k + 1 / k}^{i} {Λ}_{k + 1}^{i}}$$

(5) The overall output interaction module is configured to perform weighted fusion of the state estimation vector

$${\hat{x}}_{k + 1 / k + 1}^{i}$$

and the error covariance matrix

$${\hat{P}}_{k + 1 / k + 1}^{i}$$

of each sub-model according to the posterior probability

$${\hat{μ}}_{k + 1}^{i} ,$$

to obtain a final total output of the HPV-IMM model.

$${\hat{X}}_{k + 1 l k + 1} = {\sum }_{i = 1}^{M} {\hat{X}}_{k + 1 / k + 1}^{i} {\hat{μ}}_{k + 1}^{i} \qquad ( 25 )$$

$${\hat{P}}_{k + 1 / k + 1} = {\sum }_{i = 1}^{M} [ {\hat{P}}_{k + 1 / k + 1}^{i} + ( {\hat{X}}_{k + 1 / k + 1} - {\hat{X}}_{k + 1 / k + 1}^{i} ) \cdot {( {\hat{X}}_{k + 1 / k + 1} - {\hat{X}}_{k + 1 / k + 1}^{i} )}^{T} ] {\hat{μ}}_{k + 1}^{i} \qquad ( 26 )$$

The position and velocity of the carrier at the moment k+1 are derived from the formula (25), and the error covariance matrix measures the error of the state vector.

In the above process, to address the impact of non-Gaussian distribution observation values on the update accuracy of the measurement update module in the urban canyon scene, a multi-dimensional statistical analysis-based outlier detection algorithm is configured to identify and eliminate a gross error in the observation values, which improves an accuracy of the real-time update probability of the sub-model. The gross error in the observation values refers to a large error in the observation values, and the observation values correspond to those in the formula 12.

The process of identifying and eliminating the gross error in the observation values by the multi-dimensional statistical analysis-based outlier detection algorithm includes:
(1) input an N-dimensional pseudorange or a Doppler innovation vector L, a test threshold K₀ for comparing maximum and minimum values of a sequence with a mean, a test threshold K₁ for comparing maximum and minimum values of a sequence with a median, and a test threshold K₂ for comparing maximum and minimum values of a difference sequence;
(2) initialize an N-dimensional outlier indicator sequence (0: healthy, 1: abnormal), and set a list flag=[0 0 . . . 0]^{T}, and the number of test cycles k=0,
(3) when N−k<3, end; otherwise, remove data marked with gross errors in a sequence L;
(4) calculate test quantities:
calculate a maximum element Lₘₐₓ and a minimum element Lₘᵢₙ in the L, and their positions i, j in the sequence;
calculate a mean Mu and a median Med in the L sequence;
calculate a maximum element Dₘₐₓ and a minimum element Dₘᵢₙ in a difference sequence L;
(5) perform outlier detection: when Lₘₐₓ−Lₘᵢₙ−2Mu<K₀ && Lₘₐₓ−Med<K₁ && Med−Lₘᵢₙ<K₁ && Dₘₐₓ−Dₘᵢₙ<K₂, that is, there is no outlier, end;
(6) mark outliers: when Lₘₐₓ−Lₘᵢₙ−2Mu≥K₀∥Lₘₐₓ−Med≥K₁∥Dₘₐₓ−Dₘᵢₙ≥K₂, flag(i)=1;
when Lₘₐₓ−Lₘᵢₙ−2Mu≤−K₀∥Lₘₐₓ−Med≤−K₁∥Dₘₐₓ−Dₘᵢₙ<−K₂ flag (j)=1; and
(7) update k to k+1, and re-execute (3).

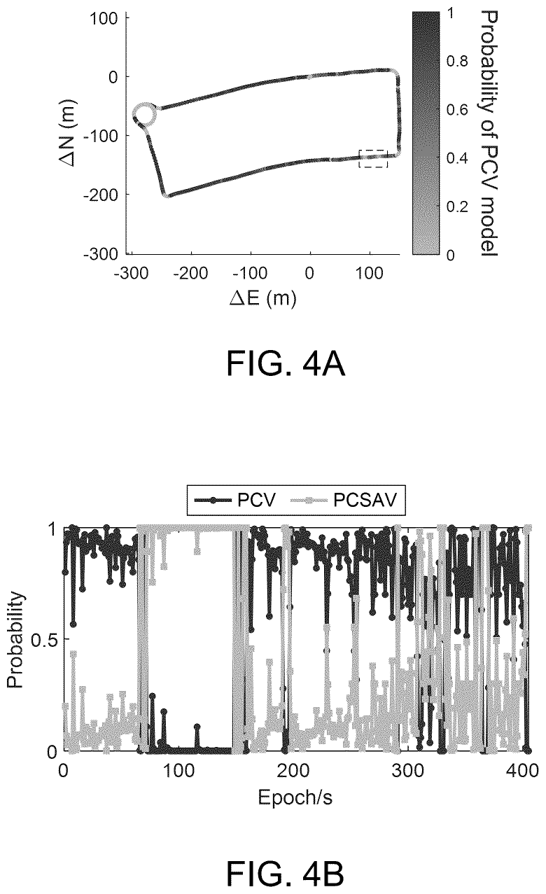

As shown in FIGS. 4A and 4B, the HPV-IMM model provided in the present disclosure successfully achieves an accurate real-time interaction between the two sub-models in an open scene, where the red line represents the probability of the PCV model and the green line represents the probability of the PCSAV model.

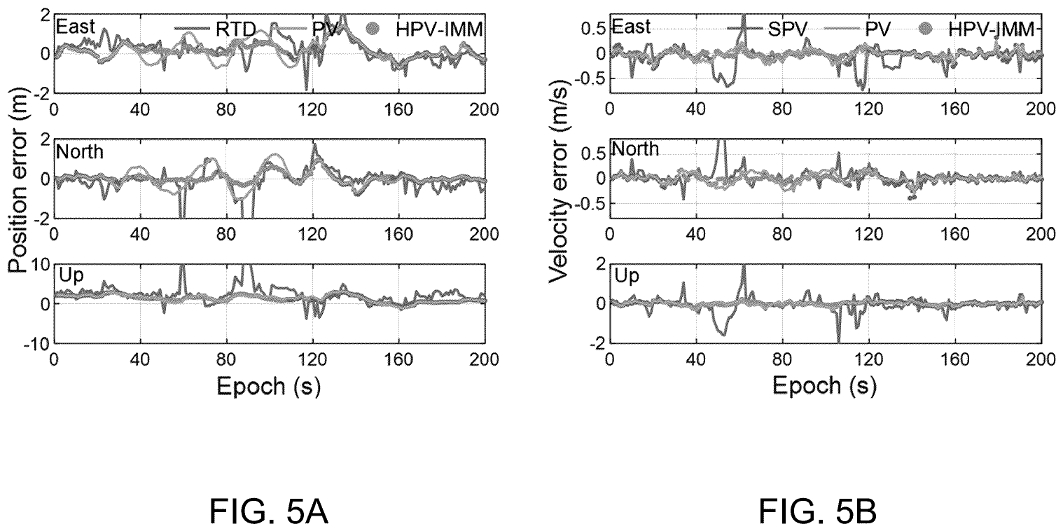

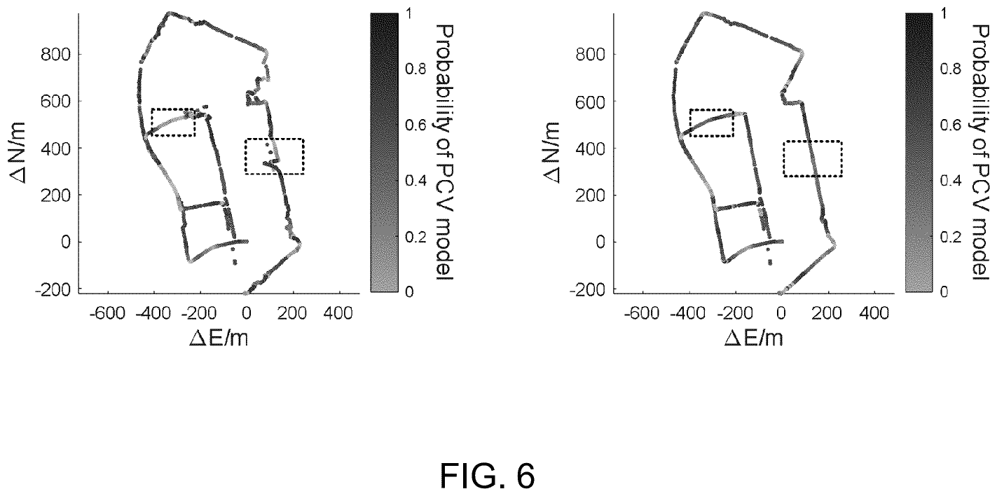

As shown in FIGS. 5A and 5B, the HPV-IMM model, compared to the RTD model, achieves smoother positioning trajectories and higher positioning accuracy, and solves the “jumping points” problem of the SPV model in terms of velocity measurement. Compared with the traditional PV model, the HPV-IMM model is approximately equivalent to the PV model when the vehicle is in the linear motion state, that is, the two models are equivalent in the accuracy of positioning and velocity measurement. When the vehicle is in the turning motion state, the HPV-IMM model with a real-time probability update mechanism makes the PCSAV model more in line with current vehicle motion behaviors have a larger weight, and is superior to the PV model in the accuracy of positioning and velocity measurement. Compared with the PV model, the model of the present disclosure improves the positioning accuracy by 27.2%, 50%, and 4.9% in the E, N, and U directions respectively. The velocity measurement accuracy is improved by 30%, 40%, and 9.0% respectively in the three directions. Additionally, as shown in FIG. 6, after the gross errors in the observation values are eliminated through the MSA-OD algorithm, the robustness of the HPV-IMM model is effectively improved.

Beneficial effects: The present disclosure has the following advantages: The IMM provided in the present disclosure fully considers the importance of the kinematic model for vehicle-mounted GNSS navigation and positioning; and based on the theorem of total probability, real-time interactions among a plurality of kinematic vehicle models are achieved through the IMM, which solves the problem of low accuracy of a traditional single kinematic model in multi-motion attitude vehicle positioning, and is suitable for dynamic navigation of the vehicle with multi-motion attitudes in urban environments.

What is claimed is:

1. A vehicle-mounted GNSS positioning method based on multi-motion model interaction, comprising:
establishing a heuristic position-velocity filtering with constant velocity model (PCV) and a position-velocity filtering with constant steering angular velocity model (PCSAV) for two attitudes of a carrier (i.e., linear motion and turning motion) respectively to obtain a state estimation vector and a state transition matrix of the carrier of the PCV model and the PCSAV model at a previous moment, wherein the state estimation vector comprises a position and velocity of the carrier, and the state transition matrix is configured to transform the state estimation vector at the previous moment into a state prediction vector at the current moment; and
introducing an interacting multiple model (IMM), and establishing a heuristic position-velocity filtering (HPV)-IMM model based on the IMM model, wherein the HPV-IMM model performs a measurement update on a state prediction vector and an error covariance matrix of the carrier of the PCV model and the PCSAV model at a current moment, to obtain the state vector and the error covariance matrix of the carrier of the PCV model and the PCSAV model at the current moment after a measurement update; and fusing the state vector and the error covariance matrix of the carrier of the PCV model and the PCSAV model at the current moment after the measurement update to obtain the state estimation vector and the error covariance matrix of the carrier at the current moment, and obtaining a position and velocity of the carrier at the current moment according to the state estimation vector of the carrier at the current moment.

2. The vehicle-mounted GNSS positioning method based on multi-motion model interaction according to claim 1, wherein in the PCV model, the state vector of the carrier to be estimated is expressed as follows:
$${X}_{P C V} = {[ x , y , z , {V}_{x} , {V}_{y} , {V}_{z} ]}_{;}$$
the state transition matrix of the carrier is expressed as follows:
$${Φ}_{P C V} = [ \begin{matrix}1 & & & dt & & \\ & 1 & & & dt & \\ & & 1 & & & dt \\ & & & 1 & & \\ & & & & 1 & \\ & & & & & 1\end{matrix} ] ;$$
in the formula, dt represents a time interval between adjacent epochs; (x,y,z) denotes a position of the carrier at a certain moment, (Vₓ,V_{y},V_{z}) signifies a velocity of the carrier at the position (x,y,z); and the state transition matrix transfers the state vector from the previous moment to the next moment according to the time interval dt.

3. The vehicle-mounted GNSS positioning method based on multi-motion model interaction according to claim 1, wherein in the PCSAV model, the state vector of the carrier to be estimated is expressed as follows:
$${X}_{P C S A V} = {X}_{P C V} ,$$
in the formula, X_{PCV} represents the state vector of the carrier to be estimated in the PCV model;
the state transition matrix of the carrier is expressed as follows:
$${Φ}_{P C T R V} = [ \begin{matrix}1 & & & \\ & 1 & & {H}^{T} Rot ( ω dt / 2 ) Hdt \\ & & 1 & \\ & & & {H}^{T} Rot ( ω dt ) H\end{matrix} ] ,$$
in the formula, ω(T) represents an angular velocity of the carrier at a moment T; and H represents a matrix of conversion from an Earth-Centered Earth-Fixed (ECEF) coordinate system to an East-North-Up (ENU) coordinate system.

4. The vehicle-mounted GNSS positioning method based on multi-motion model interaction according to claim 1, wherein the HPV-IMM model comprises a state interaction input module, a state prediction module, an innovation outlier detection module, a measurement update module, and an overall output interaction module;
the state interaction input module, according to an estimation result of a state vector of the carrier of an i^{th} sub-model at a previous moment k, calculates an initial state vector
$${\tilde{X}}_{k + 1 / k}^{i}$$
and an error covariance matrix
$${\tilde{P}}_{k + 1 / k}^{i}$$
of the carrier of the i^{th} sub-model at a current moment k+1, wherein when i=1, the i^{th} sub-model represents the PCV model, and when i=2 or M, the i^{th} sub-model represents the PCSAV model, and M=2 represents the number of sub-models;
according to the initial state vector
$${\tilde{X}}_{k + 1 / k}^{i}$$
and the error covariance matrix
$${\tilde{P}}_{k / k}^{i} ,$$
the state prediction module predicts a motion state of the carrier of the i^{th} sub-model from the moment k to the moment k+1, and calculates a state prediction vector
$${\overline{X}}_{k + 1 / k}^{i}$$
and an error covariance matrix
$${\overline{P}}_{k + 1 / k}^{i}$$
of the carrier of the i^{th} sub-model from the moment k to the moment k+1;
according to the state prediction vector
$${\overline{X}}_{k + 1 / k}^{i}$$
and the error covariance matrix
$${\overline{P}}_{k + 1 / k}^{i}$$
of the carrier of the i^{th} sub-model, the innovation outlier detection module calculates an innovation sequence
$${L}_{k + 1}^{i}$$
of the i^{th} sub-model at the moment k+1;
the measurement update module comprises a measurement update and a sub-model probability update, wherein the measurement update is performed based on the state prediction vector
$${\overline{x}}_{k + 1 / k}^{i} ,$$
the error covariance matrix
$${\overline{P}}_{k + 1 / k}^{i} ,$$
and the innovation sequence
$${L}_{k + 1}^{i}$$
of the carrier of the i^{th} sub-model to obtain a state vector
$${\hat{x}}_{k + 1 / k + 1}^{i}$$
and an error covariance matrix
$${\hat{P}}_{k + 1 / k + 1}^{i}$$
of the carrier of the i^{th} sub-model after the measurement update; for the sub-model probability update, similarity between a motion state of the carrier predicted by the i^{th} sub-model and a current motion state of the carrier is calculated to obtain a posterior probability
$${\hat{μ}}_{k + 1}^{i}$$
of the i^{th} sub-model;
the overall output interaction module performs weighted fusion of the state estimation vector
$${\hat{x}}_{k + 1 / k + 1}^{i}$$
and the error covariance matrix
$${\hat{P}}_{k + 1 / k + 1}^{i}$$
of the carrier of the i^{th} sub-model according to the posterior probability
$${\hat{μ}}_{k + 1}^{i} ,$$
to obtain \hat{X}_{k+1/k+1} and the error covariance matrix \hat{P}_{k+1/k+1}; and
the position and velocity of the carrier at the moment k+1 are calculated based on the overall state estimation vector of the carrier at the moment k+1.

5. The vehicle-mounted GNSS positioning method based on multi-motion model interaction according to claim 4, wherein the initial state vector
$${\tilde{X}}_{k + 1 / k}^{i}$$
and the error covariance matrix
$${\tilde{P}}_{k + 1 / k}^{i}$$
of the carrier of the iₜₕ sub-model are expressed as follows:
$${\tilde{X}}_{k / k}^{i} = {\sum }_{j = 1}^{M} {\hat{X}}_{k / k}^{j} {μ}_{k + 1 / k}^{i \vert j} , {\tilde{P}}_{k / k}^{i} = {\sum }_{j = 1}^{M} [ {\hat{P}}_{k / k}^{j} + ( {\tilde{X}}_{k / k}^{i} - {\hat{X}}_{k / k}^{j} ) {( {\tilde{X}}_{k / k}^{i} - {\hat{X}}_{k / k}^{j} )}^{T} ] {μ}_{k / k + 1}^{i \vert j} ;$$
in the formula,
$${m}_{k}^{i} ⊏ \{ {P}_{k - 1 / k - 1}^{i} , {Φ}_{k}^{i} , {Q}_{k}^{i} , {B}_{k}^{i} , {R}_{k}^{i} \}$$
represents parameters of the i^{th} sub-model at the moment k, comprising an error covariance matrix
$${P}_{k - 1 / k - 1}^{i} ,$$
a state transition matrix
$${Φ}_{k}^{i} ,$$
a process noise matrix
$${Q}_{k}^{i} ,$$
a coefficient matrix
$${B}_{k}^{i} ,$$
and an observation noise matrix
$${R}_{k}^{i} ;$$
$${Z}_{k} = [ {Z}_{k}^{P R} , {Z}_{k}^{D O P} ] ,$$
represents observation data at the moment k, comprising a pseudorange value
$${Z}_{k}^{P R}$$
and a Doppler measurement value
$${Z}_{k}^{D O P}$$
of a satellite;
$${μ}_{k + 1 / k}^{i \vert j} ⊔ P \{ {m}_{k + 1}^{i} \vert {m}_{k}^{j} , {Z}_{k}^{j} \} = \frac{{π}_{ij} {\hat{μ}}_{k}^{j}}{{\overline{μ}}_{k + 1 / k}^{i}} ,$$
represents a probability of transition from
$${m}_{k}^{j} to {m}_{k + 1}^{i} ; {\overline{μ}}_{k + 1 / k}^{i} = {\sum }_{j = 1}^{M} {π}_{ij} {\hat{μ}}_{k}^{j} ,$$
represents a probability of the sub-model after an interaction in the interaction input module, which is calculated based on a prior transition probability matrix π and a model posterior probability
$${\hat{μ}}_{k}^{j} ,$$
wherein the transition probability matrix is set as
$$π = [ \begin{matrix}0.95 & 0.05 \\ 0.05 & 0.95\end{matrix} ] .$$

6. The vehicle-mounted GNSS positioning method based on multi-motion model interaction according to claim 4, wherein the state prediction vector
$${\overline{x}}_{k + 1 / k}^{i}$$
and the error covariance matrix
$${\overline{P}}_{k + 1 / k}^{i}$$
of the carrier of the i^{th} sub-model from the moment k to the moment k+1 are expressed as follows:
$${\overline{X}}_{k + 1 l k}^{i} = {Φ}_{k + 1}^{i} {\tilde{X}}_{k / k}^{i} , {\overline{P}}_{k + 1 / k}^{i} = {Φ}_{k + 1}^{i} {\tilde{P}}_{k / k}^{i} {Φ}_{k + 1}^{i T} + {Q}_{k + 1}^{i} ;$$
in the formula,
$${Φ}_{k + 1}^{i}$$
represents a state transition matrix of the carrier of the i^{th} sub-model at the moment k+1, and
$${Q}_{k + 1}^{i}$$
represents a process noise matrix of the carrier of the i^{th} sub-model at the moment k+1.

7. The vehicle-mounted GNSS positioning method based on multi-motion model interaction according to claim 4, wherein the innovation sequence Lⁱₖ₊₁ of the i^{th} sub-model at the moment k+1 is expressed as follows:
$${L}_{k + 1}^{i} = {\tilde{Z}}_{k + 1} - {B}_{k + 1}^{i} {\overline{X}}_{k + 1 / k}^{i} ;$$
in the formula, \tilde{Z}ₖ₊₁ represents observation data after gross error elimination at the moment k+1, and
$${B}_{k + 1}^{i}$$
represents a coefficient matrix of the i^{th} sub-model at the moment k+1.

8. The vehicle-mounted GNSS positioning method based on multi-motion model interaction according to claim 7, wherein a multi-dimensional statistical analysis-based outlier detection algorithm is configured to identify and eliminate an observation gross error in the observation values, and the observation gross error refers to an error of the observation values greater than a preset threshold of observation values.

9. The vehicle-mounted GNSS positioning method based on multi-motion model interaction according to claim 4, wherein the state estimation vector
$${\hat{x}}_{k + 1 / k + 1}^{i}$$
and the error covariance matrix
$${\hat{P}}_{k + 1 / k + 1}^{i}$$
of the carrier of the i^{th} sub-model after the measurement update are expressed as follows:
$${\hat{X}}_{k + 1 / k + 1}^{i} = {\overline{X}}_{k + 1 / k}^{i} + {K}_{k + 1}^{i} {L}_{k + 1}^{i} , {\hat{P}}_{k + 1 / k + 1}^{i} = ( I - {K}_{k + I}^{i} {B}_{k + 1}^{i} ) {\overline{P}}_{k + 1 / k}^{i} ;$$
in the formula, I represents an identity matrix, and
$${B}_{k + 1}^{i}$$
represents the coefficient matrix of the i^{th} sub-model at the moment k+1;
$${K}_{k + 1}^{i}$$
represents a Kalman gain
$${K}_{k + 1}^{i} = {\overline{P}}_{k + 1 / k}^{i} {{B}_{k + 1}^{i T} ( {B}_{k + 1}^{i} {\overline{P}}_{k + 1 / k}^{i} {B}_{k + 1}^{i T} + {R}_{k + 1}^{i} )}^{- 1} ;$$
the posterior probability
$${\hat{μ}}_{k + 1}^{i}$$
of the i^{th} sub-model is expressed as follows:
$${\hat{μ}}_{k + 1}^{i} = \frac{{\overline{μ}}_{k + 1 / k}^{i} {Λ}_{k + 1}^{i}}{{\sum }_{i = 1}^{M} {\overline{μ}}_{k + 1 / k}^{i} {Λ}_{k + 1}^{i}} ;$$
in the formula,
$${Λ}_{k + 1}^{i}$$
represents a likelihood function value of the i^{th} sub-model at the moment k+1, and
$${\overline{μ}}_{k + 1 / k}^{i}$$
represents a probability of the sub-model after an interaction in the interaction input module.

10. The vehicle-mounted GNSS positioning method based on multi-motion model interaction according to claim 4, wherein the \hat{X}_{k+1/k+1} and the error covariance matrix \hat{P}_{k+1/k+1} obtained after the weighted fusion, i.e., the overall state estimation vector and the error covariance matrix of the carrier at the moment k+1 are expressed as follows:
$${\hat{X}}_{k + 1 / k + 1} = {\sum }_{i = 1}^{M} {\hat{X}}_{k + 1 / k + 1}^{i} {\hat{μ}}_{k + 1}^{i} , {\hat{P}}_{k + 1 / k + 1} = {\sum }_{i = 1}^{M} [ {\hat{P}}_{k + 1 / k + 1}^{i} + ( {\hat{X}}_{k + 1 / k + 1} - {\hat{X}}_{k + 1 / k + 1}^{i} ) \cdot {( {\hat{X}}_{k + 1 / k + 1} - {\hat{X}}_{k + 1 / k + 1}^{i} )}^{T} ] {\hat{μ}}_{k + 1}^{i} .$$
